(19) United States
(12) Patent Application Publication
(10) Pub. No.: US 2011/0013996 A1
(43) Pub. Date: Jan. 20, 2011

(54) INDEXABLE CUTTING INSERT FOR A MILLING TOOL

(76) Inventor: Franz Josef Pokolm, Harsewinkel (DE)

Correspondence Address: COHEN & GRIGSBY, P.C., 625 LIBERTY AVENUE, PITTSBURGH, PA, 15222-3152, US

(21) Appl. No.: 12/933,273

(22) PCT Filed: Mar. 17, 2009
(86) PCT No.: PCT/EP2009/053154

§ 371 Date: Sep. 17, 2010

(30) Foreign Application Priority Data
Mar. 18, 2008 (DE) 202008000027.0
Oct. 8, 2008 (DE) 202008008863.1

(51) Int. Cl. B23C 5/22; B23C 5/02

(52) U.S. Cl. 407/48; 407/115

(57) ABSTRACT

An indexable cutting insert (1) for a milling tool (2) for machining work pieces, said indexable cutting insert being rotationally mounted in a radial manner on a milling head (3), on a rotationally symmetrical design ed Y-axis (4) on the milling head (3). According to the invention, said indexable cutting insert (2) is arranged below a tolerance play (5) in a freely rotating manner on the free end (6) of a mounting pin (7) secured in a detachable manner to the milling head (3) below the clamping seat. The freely rotationally mounted indexable cutting insert (1) is mounted or surrounded on the entire surface of the rear side (9) and on certain parts on the front side (10) such that the mounting pin (7) does not detach itself from the material (9) of the milling head.

### BACKGROUND OF THE INVENTION

The invention relates to an indexable cutting insert for a milling tool for machining work pieces, said indexable cutting insert being radially mounted in rotatable manner on a milling head on a rotation-symmetrically designed Y axis on the milling head.

### PRIOR ART

Machining with rotating blades has been a well known procedure for years though the procedure has obtained distinctiveness in manufacture to only a small degree. In the present case, a tool is used the active element whereof comprises a round, rotatably mounted disk blade, said disk blade executing during the machining process an automatic rotational movement kinematicly-based on the machining process and the fact that the disk blade axis is slanted in relation to the cutting direction. Due to the said rotating movement of the disk blade during machining, a new part of the blade is always engaged in continuous sequence, whereby each point on the blade remains only briefly in the cutting zone, which causes only slight heating of the disk blade.

A corresponding milling cutter here is known, for example, from the patent application DD 118 543. In this embodiment, not only a rotating rotary disk, but also a fixed blade is provided on the milling head, in order to in this way achieve a particular cutting design. A further embodiment of the prior art is also known from the patent application U.S. Pat. No. 2,885,766, wherein indexable cutting inserts rotatably mounted in the milling head are provided, said indexable cutting inserts being mounted rotatably on the milling head on rotation-symmetrically designed axes. With this milling head known from the prior art, the rotatably mounted indexable cutting inserts are disposed in U-shaped nests so that the axes are, in particular, embedded on both sides in the milling head.

In addition, further embodiments are known to the art such as, for example, are described in the patent application U.S. Pat. No. 5,478,175. This publication discloses a rotatable blade equipped with a shank formed integrally to the rear side thereof, said shank being rotatably mounted in a pocket hole bore in the carrier material of the milling head. An equivalent solution is also known to the art from the patent application DE 10 2005 051 695, wherein, in particular, the indexable cutting insert is attached to a carrier element and wherein the carrier element is rotatably held in the tool. In this case, the carrier element is equipped coaxially to the Y axis with a shaft end rotatably disposed in a pocket hole bore in the tool. In this embodiment known according to the prior art, in particular, the carrier element provided may also be designed as actively turn-actuated so that, due to the rotational movement of the milling tool, the cutting insert attached to the carrier here is also driven by a transmission gear provided in the milling head. A corresponding embodiment is also described in the patent application CH 480 120.

With the said solutions for milling tools known from the prior art which are equipped with rotatably mounted cutting disks, it is considered as disadvantageous that the embodiments known to the art are very costly to build with regard to their rotatably mounted indexable cutting inserts, which is due to the costly design of the mounting for the indexable cutting insert. Thus, for example, all solutions known from the prior art have in common that, in particular, in order to exchange the indexable cutting insert, though rotatably mounted, the execution of several operations on the milling head is necessary to on the one hand, detach the indexable cutting insert out of the milling head and/or on the other hand, after detaching the carrier means, the indexable cutting insert still has to be detached from the carrier means itself. An additional disadvantage of the solutions known to the art is seen in the fact that in particular with regard to the storage inventory of rotatably mounted indexable cutting inserts, indexable cutting inserts particularly adapted to the milling head have to be kept available in storage.

### SUMMARY OF THE INVENTION

### Object

The invention therefore has the object of offering an indexable cutting insert for a milling head for machining work pieces, said indexable cutting insert being radially rotatably mounted, where the design of said milling head for mounting the blades is substantially simpler, and, in particular, the process of exchanging the cutting insert is substantially simpler.

Solution

According to the invention, the object is achieved with the features of claim 1, and advantageous embodiments of the invention ensue from the sub-claims.

The advantages obtained with the invention, in particular, include the fact that as a consequence of a pin solution in conjunction with the envelopment of the rotating indexable cutting insert by the carrier material of the milling head, an indexable cutting insert rotating in a cage is created, said indexable cutting insert having sufficient motion freedom and/or rotational freedom to on the one hand, penetrate the material during the drilling process and on the other hand, be able to remove a corresponding chip during machining. The simple embedment of the indexable cutting insert here is only achieved by the shape of the milling head in conjunction with the mounting pin. Thereby it is guaranteed that the rotating disk has, in particular during machining, sufficient rotational freedom without incurring the risk that the blades might separate from their mountings by themselves.

The indexable cutting insert here is disposed freely rotatably under a tolerance play on the free end of a mounting pin, said mounting pin being detachably attached with braced seating to the milling head, and the freely rotatably mounted indexable cutting insert is enveloped by and/or embedded in the material of the milling head, on the one hand on the entire surface of the rear side and on the other hand, on parts of the frontal side in a way to prevent a self-detachment from the mounting pin. Due to the detachably attached mounting pin forming the rotational axis for the indexable cutting insert, it is guaranteed that by simply detaching the mounting pin, the indexable cutting insert is released within the cage thereof so that it is possible to simply remove the indexable cutting insert from its nest or allow the same to drop therefrom. For this purpose, the mounting pin is disposed in a penetrating bore on the milling head. It is now easily understood that the mounting pin can easily be pushed through from one side so that, in particular, the mounting pin releases the indexable cutting insert from its seat and allows it to be removed from the nest.

According to a particularly advantageous development of the indexable cutting insert, said indexable cutting insert is equipped with a cylindrical bore for the formation of a sliding mounting on the mounting pin. On the frontal part, the indexable cutting insert has a ring-shaped area comprising a smooth disk surface for the formation of a sliding ring, said sliding ring being supported under stress on the enveloping and surrounding area of the milling head.

According to a particularly advantageous development of the shape, the indexable cutting insert is, according to an initial embodiment, equipped with an enveloped cutting edge. The indexable cutting insert here can also, according to a second embodiment, be equipped with a cutting edge gradually stepped in relation to the disk surface. The said stepped cutting edge may also be furnished with a chip trough.

The indexable cutting insert inserted in the milling head here is located in the milling head in such a way that the cutting edge of the indexable cutting insert is located in an area recessed within the enveloping and/or surrounding material of the milling head. The enveloping and/or surrounding material of the milling head here works in conjunction only with the disk surface.

Due to the pin solution in conjunction with the envelopment of the rotating indexable cutting insert by the carrier material of the milling head, an indexable cutting insert rotating within a cage is created, said indexable cutting insert having sufficient motion freedom and/or rotational freedom to on the one hand, penetrate into the material during the drilling process and on the other hand, during machining to remove a corresponding chip without impediment and without baked-on material, be it on the carrier material or on the indexable cutting insert itself. The simple embedment of the indexable cutting insert here is achieved solely by the shape of the milling head in conjunction with the mounting pin. Thus it is guaranteed that the rotating disk has, in particular during machining, sufficient rotational freedom without incurring the risk that the blades might separate from their mountings by themselves.

The mounting pin here has at the other end a tapped area wherewith the said mounting pin is fixed in the material of the milling head. The mounting pin is equipped such that it has a frontal cylindrical area for the rotational mounting of the indexable cutting insert, and, in the central area, a conically designed area for the fixation in the carrier material of the milling head. The tapped section provided for bracing in the carrier material then abuts the conical area so that the pin can be inserted in the carrier material of the milling head and be braced therein, and that thus said pin occupies a stable mounting axis for the free rotational mounting of the indexable cutting insert. It is easily understood that for bracing the mounting pin, the conical design accordingly works in conjunction with a conicity in the milling head material. When the tapped pin is screwed in, the pin tightens itself against the conical surfaces, which effects a stabilization of the rotational axis. In order to operate and/or brace the pin, a hex socket is disposed coaxially to the shank axis of the mounting pin.

According to a particularly advantageous development of the indexable cutting insert, the said indexable cutting insert is equipped with a circumferential groove wherein engages a track ring or cog disposed on the milling head. The circumferential groove here is radially disposed on the indexable cutting insert. According to an alternative embodiment, the circumferential groove is disposed on the rear bearing surface or support surface of the indexable cutting insert. Thus it is achieved that, in particular, the cutting insert receives, aside from the free rotational mounting on the mounting pin, an additional guidance stability in the rotation, either due to a track ring or a cog.

### BRIEF DESCRIPTION OF THE DRAWINGS

An embodiment of the invention is represented in the drawings 1 through 12 in purely schematic manner and is described in more detail below. The drawings show in:

FIG. 1: an embodiment of a milling tool according to the invention, wherein the milling cutter is represented with at least one enveloped indexable cutting insert in a lateral view a, a perspective view b, a top view c, a sectional lateral view d, as well as a detail view e;

FIG. 1.1: a further detail view e with a free space in the material on the milling tool;

FIG. 1.2: a further detail view e with a stepped cutting edge according to FIG. 3;

FIG. 1.3: a further detail view e with a chamfered-on cutting edge according to FIG. 2;

FIG. 1.4: a further detail view e of the cutting edge with a chip trough according to FIG. 4;

FIG. 2: FIG. 2 shows an initial embodiment of an indexable cutting insert in different representations, such as a lateral view a, a top view b, a sectional lateral view c, as well as a detail view d;

FIG. 3: a second embodiment of an indexable cutting insert, also in different views a through d;

FIG. 4: a third embodiment of an indexable cutting insert, also in different views a through d;

FIG. 5: a sectional lateral view of the milling tool according to the invention;

FIG. 6: a top view of the milling tool according to the invention according to FIG. 5;

FIG. 7: a further lateral view of the milling tool according to the invention according to FIG. 6;

FIG. 8: a component view of the mounting pin in lateral and in frontal view;

FIG. 9: an exposed representation of the mounting pin with cutting insert according to FIG. 5 in an initial embodiment;

FIG. 10: a further exposed representation of the mounting pin with cutting edge according to FIG. 5 in a second embodiment;

FIG. 11: a component view in sectional representation of an Indexable cutting insert in sectional representation; and

FIG. 12: a further embodiment of an indexable cutting insert, also in sectional representation.

### BEST WAY OF CARRYING OUT THE INVENTION

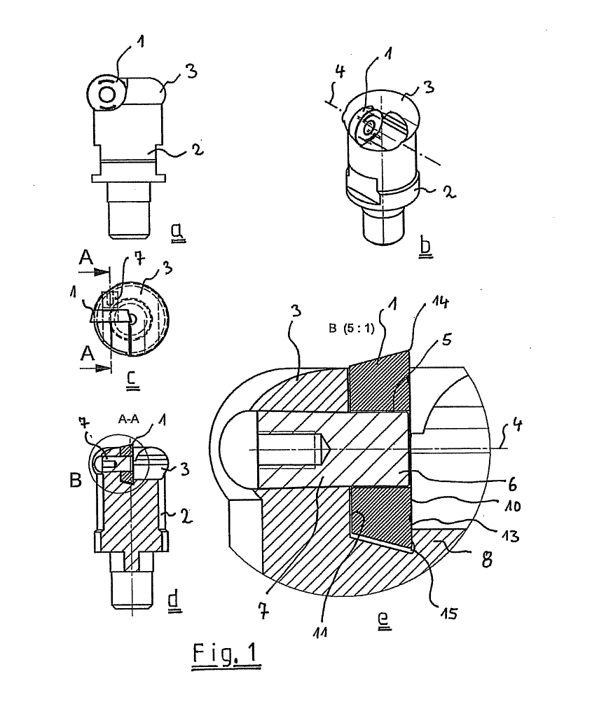

In the embodiment of a basic form, FIG. 1 shows an indexable cutting insert 1 for a milling tool 2 for machining work pieces. The indexable cutting insert 1 here is radially mounted rotatably on a milling head 3 on a rotation-symmetrically designed Y axis 4 on the milling head 3. FIG. 1 here shows the milling tool 2 with the indexable cutting insert 1 in five different views, wherein FIG. 1 a shows a lateral view of the milling tool 2 with the indexable cutting insert 1, FIG. 1 b shows a perspective top view, FIG. 1 c shows a view of the milling head 3 with the embedded indexable cutting insert 1, FIG. 1 d shows a sectional detail view of the milling head 3 with the indexable cutting insert 1, and FIG. 1 e shows an exposed representation of the embedment of the indexable cutting insert 1 on the milling head 3.

The indexable cutting insert 1 here is disposed under a tolerance play 5 freely rotatably on the free end 6 of a mounting pin 7, said mounting pin 7 being detachably attached with braced seating on the milling head 3. The freely rotatably mounted indexable cutting insert 1, in order to prevent a self-detachment from the mounting pin 7, here is enveloped and/or surrounded by the material 8 of the milling head 3, on the one hand on the entire surface of the rear side 9; and on the other hand, in parts on the frontal side 10. As can be seen from FIG. 1 overall, the indexable cutting insert 1 is equipped with a cylindrical bore 11 for the formation of a sliding mounting on the mounting pin 7. The indexable cutting insert 1 here is equipped on the frontal side 10 thereof with a ring-shaped area 12 comprising a smooth disk surface for forming a sliding ring, said sliding ring being supported under stress on the enveloping, surrounding material 8 of the milling head 3. This becomes clear from the detail view of FIG. 1 e, wherein the material 8 of the milling head 3 stretches all the way to the ring-shaped area 12 of the indexable cutting insert 1.

The indexable cutting insert 1 with the blade 14, rotatably mounted under a tolerance play 5 on the mounting pin 7, is surrounded by a free space 15 in the material 8 so that there is sufficient free space for any material sticking to the blade 14 so that the indexable cutting insert 1 has sufficient rotational freedom.

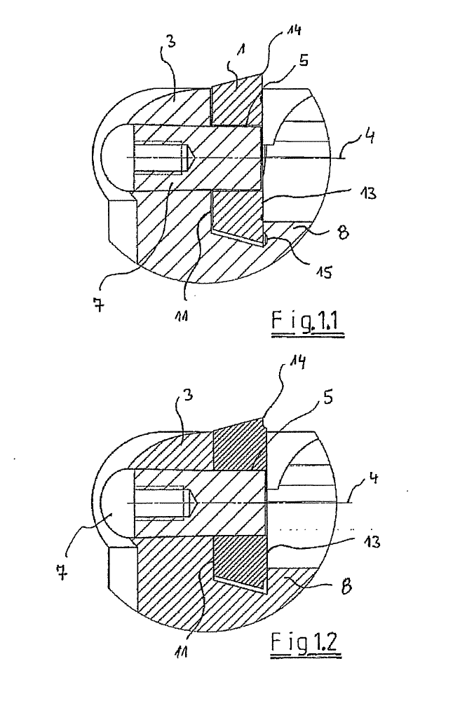

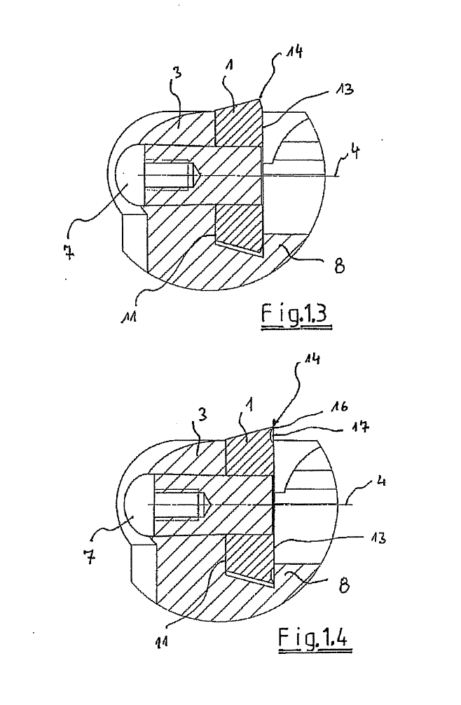

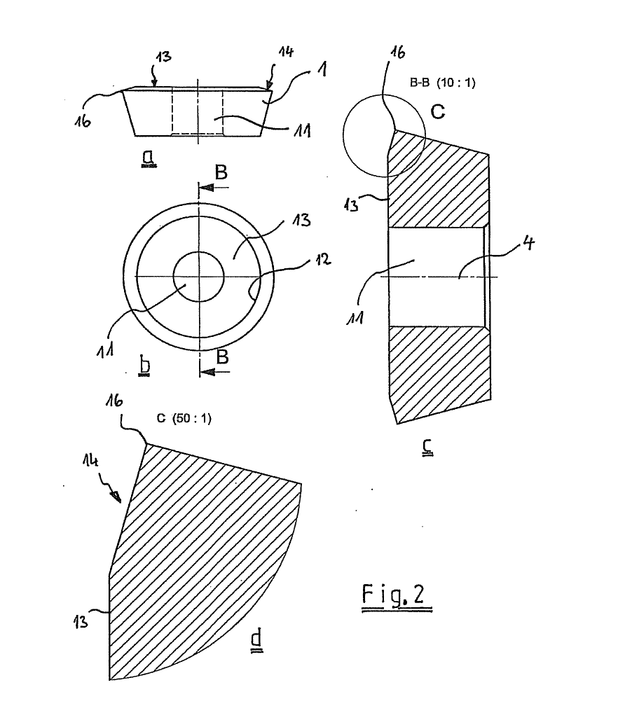

According to a further embodiment of the indexable cutting insert 1, represented in FIG. 2, the indexable cutting insert 1 shown there has a chamfered-on cutting edge 16.

According to FIG. 3, a development of the indexable cutting insert 1 is shown, where the said indexable cutting insert 1 is equipped with a cutting edge 16, said cutting edge 16 being gradually stepped in relation to the disk surface 13.

A development of the indexable cutting insert 1 represented according to FIG. 3 is shown in FIG. 4, where the indexable cutting insert 1 is equipped with a cutting edge 16, said cutting edge 16 being stepped in relation to the disk surface 13 and having a chip trough 17.

As already described above, the cutting edge 16 of the indexable cutting insert 1 is located in a space recessed within the enveloping and/or surrounding material 8 of the milling head 3. The enveloping and/or surrounding material 8 of the milling head 3 here works only in conjunction with the disk surface 13.

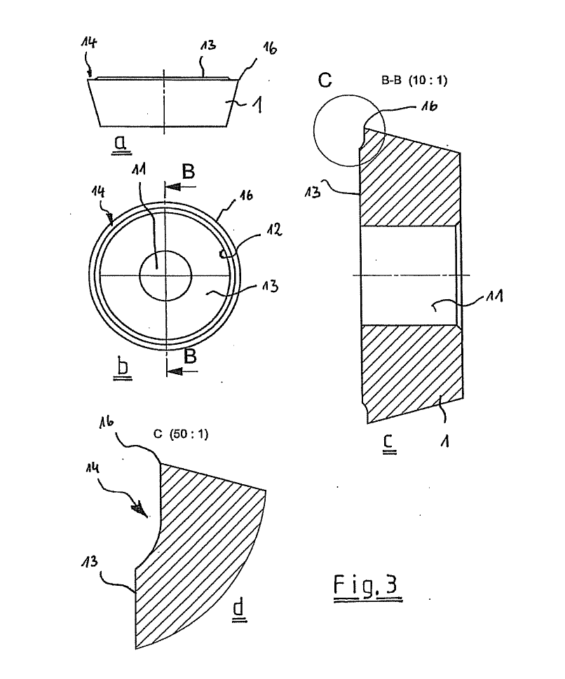

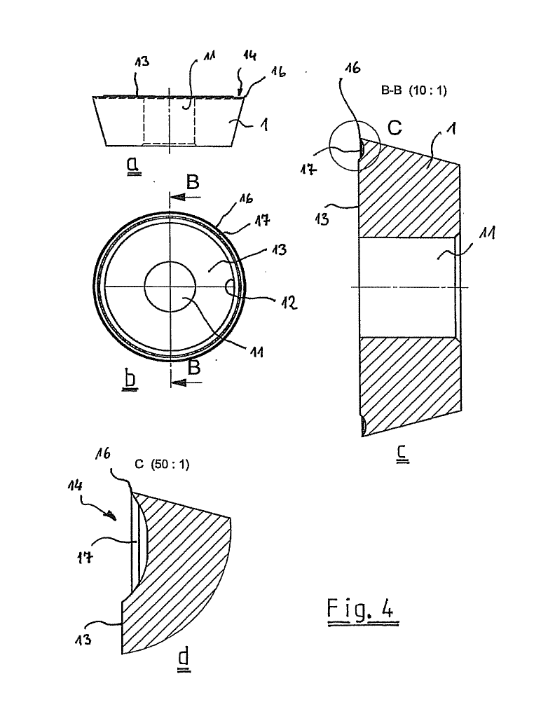

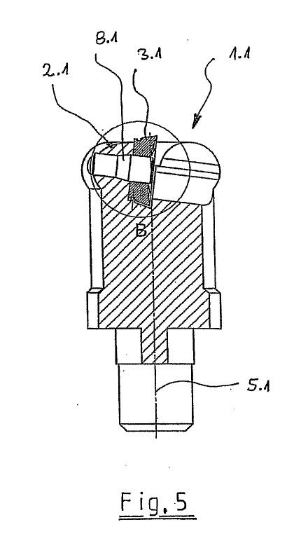

FIG. 5 shows an embodiment of a milling tool 1.1 according to the invention in the sectional lateral view. The milling tool 1.1 here is destined for machining work pieces, and at least one radially mounted indexable cutting insert 3.1 is provided on the milling head 2.1 of the milling tool 1.1, said indexable cutting insert 3.1 being rotatably mounted on a rotation-symmetrically designed Y axis 4.1 on the milling head 2.1. As can be seen, in particular, from the representation of FIG. 5, the Z axis forms the rotational axis 5.1 of the milling tool 1.1, while the X axis occupies the cutting horizon designated with the reference number 6.1.

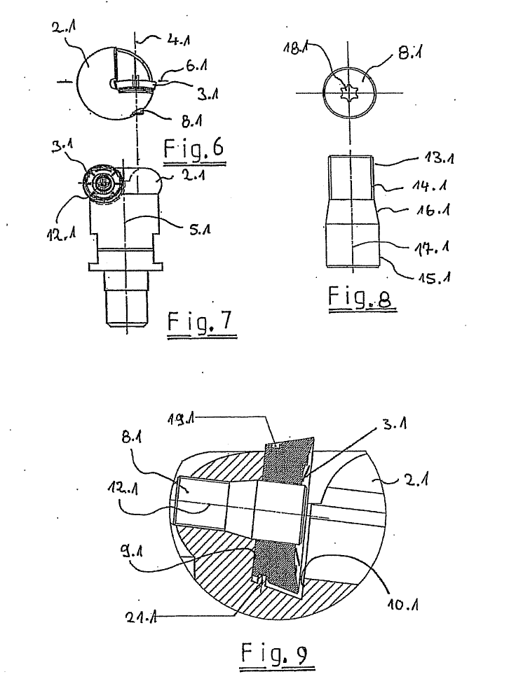

It is now easily understood that the Y axis 4.1 is provided to run rotation-symmetrically on the milling head 2.1, while the said Y axis 4.1 runs at an offset in relation to the rotational axis 5.1. This can be particularly clearly seen in FIGS. 6 and 7. As can be seen, in particular, from the overall view of FIGS. 5, 9, and 10, the indexable cutting insert 3.1 is freely rotatably disposed under a tolerance play on the free end 7.1 of a mounting pin 8.1, said mounting pin 8.1 being detachably attached with braced seating on the milling head 2.1. The freely rotatably mounted indexable cutting insert 3.1 here is secured against a self-detachment from the mounting pin 8.1, since the said indexable cutting insert 3.1 is enveloped by and/or embedded in the material of the milling head 2.1, on the one hand on the entire surface of the rear side 9.1, and on the other hand, in parts on the frontal side 10.1. This can, in particular, be seen from the view of FIG. 5, where it becomes clear that an area on the frontal side 10.1 of the indexable cutting insert 3.1 is overlapped by the material of the milling head 2.1.

Thus it becomes clear, when considering FIGS. 5 and 9, that the indexable cutting insert 3.1 is held as in a restraining cage, and that the said restraining cage is determined on the one hand, by the free end 7.1 of the mounting pin 8.1, said mounting pin 8.1 engaging in the central bore 11.1 of the indexable cutting insert 3.1, and on the other hand, by the shape determined by the milling cutter material and protruding over the mounted indexable cutting insert 3.1 from the frontal side 10.1, in conjunction with the rear support surface.

In a development of, in particular, a stable rotational axis 12.1 for the indexable cutting insert 3.1, the mounting pin 8.1 is equipped on the other end 13.1 thereof with a tapped area 14.1 serving to fix the said mounting pin 8.1 in the material of the milling head 2.1. As can be seen from FIG. 8 in the component view of the mounting pin 8.1, the mounting pin 8.1 is equipped with a frontal cylindrical area 15.1 for the rotational mounting of the indexable cutting insert 3.1, wherein the said mounting pin 8.1 in the central area 16.1 thereof is equipped with a conically designed area for the fixation in the carrier material of the milling head 2.1. The tapped area 14.1 of the mounting pin 8.1 intended for bracing in the carrier material then abuts onto the conical area. As can further be seen from FIG. 8, a hex socket 18.1 allowing the connection of a tool is here disposed coaxially to the shank axis 17.1 of the mounting pin 8.1.

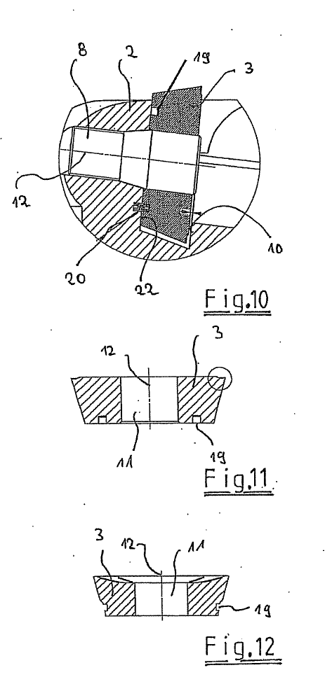

In a development of the invention, in particular represented in FIGS. 9, 10, 11, and 12, the freely rotatably mounted indexable cutting insert 3.1 is equipped with a circumferential groove 19.1, wherein engages a track ring 20.1 or cog 21.1 disposed on the milling head 2.1. With this design, centrifugal force is used to secure the indexable cutting inserts 3.1. The circumferential groove 19.1 here can be radially disposed on the indexable cutting insert 3.1, as is represented in FIGS. 9 and 12. Another embodiment is shown in FIGS. 10 and 11, wherein the circumferential groove 19.1 is disposed on the rear support surface 22.1 of the indexable cutting insert 3.1. In order to embed the indexable cutting insert 3.1, at first the indexable cutting insert 3.1 is inserted without the mounting pin 8.1 into the positive lock connections of the track ring 20.1 or cog 21.1 so that the indexable cutting insert 3.1 rests against the track ring 20.1 on the frontal or on the rear surface, or, according to the other embodiment, the indexable cutting insert 3.1 engages with the cog 21.1 in the circumferential groove 19.1. Thus a predetermined fine adjustment of the indexable cutting insert 3.1 in the cage is provided. In order to fix the indexable cutting insert 3.1 within the cage thereof, the mounting pin 8.1 now is inserted, and the said mounting pin 8.1 tightens and braces itself in the carrier material of the milling head 2.1, thereby providing a rigid rotational axis 12.1 for the indexable cutting insert 3.1. If now the indexable cutting insert 3.1 is to be exchanged, the mounting pin 8.1 is first unscrewed via the hex socket 18.1, while the indexable cutting insert 3.1 initially remains in position. Once the mounting pin 8.1 has been removed, the indexable cutting insert 3.1 can then easily and simply be removed from the nest.

### LIST OF REFERENCE NUMBERS

1. indexable cutting insert
2. milling tool
3. milling head
4. axis
5. tolerance play
6. free end
7. mounting pin
8. material
9. rear side
10. frontal side
11. bore
12. ring-shaped area
13. disk surface
14. blade
15. free space
16. cutting edge
17. chip trough
   1.1 milling tool
   2.1 milling head
   3.1 indexable cutting insert
   4.1 Y axis
   5.1 Z axis
   6.1 X axis
   7.1 free end
   8.1 mounting pin
   9.1 rear side
   10.1 frontal side
   11.1 central bore
   12.1 rotational axis
   13.1 other end
   14.1 tapped area
   15.1 cylindrical area
   16.1 central area
   17.1 shank axis
   18.1 hex socket
   19.1 groove
   20.1 track ring
   21.1 cog
   22.1 support surface

1. An indexable cutting insert (1) for a milling tool (2) for machining work pieces, said indexable cutting insert being radially mounted rotatably on a milling head (3) on a rotation-symmetrically designed Y axis (4) on the milling head (3), characterized in that the indexable cutting insert (1) is disposed under a tolerance play (5) freely rotatably on the free end (6) of a mounting pin (7), said mounting pin (7) being detachably attached with braced seating on the milling head (3), wherein the freely rotatably mounted indexable cutting insert (1), in order to prevent a self-detachment from the mounting pin (7), is enveloped and/or surrounded by the material (8) of the milling head (3), on the one hand on the entire surface of the rear side (9) and on the other hand, in part on the frontal side (10).

2. An indexable cutting insert (1) according to claim 1, characterized in that the indexable cutting insert (1) is equipped with a cylindrical bore (11) for the formation of a sliding mounting on the mounting pin (7).

3. An indexable cutting insert (1) according to claim 2, characterized in that the indexable cutting insert (1) is equipped on the frontal side (10) with a ring-shaped area (12) comprising a smooth disk surface (13) for the formation of a sliding ring supported under stress on the enveloping, surrounding material (8) of the milling head (3).

4. An indexable cutting insert (1) according to claims 1 through 3, characterized in that the indexable cutting insert (1) is equipped with a chamfered-on cutting edge (16).

5. An indexable cutting insert (1) according to claims 1 through 4, characterized in that the indexable cutting insert (1) is equipped with a cutting edge (16), said cutting edge being gradually stepped in relation to the disk surface (13).

6. An indexable cutting insert (1) according to claims 1 through 5, characterized in that the indexable cutting insert (1) is equipped with a cutting edge (16), said cutting edge (16) being stepped in relation to the disk surface (13) and having a chip trough (17).

7. An indexable cutting insert (1) according to claims 1 through 6, characterized in that the cutting edge (16) of the indexable cutting insert (1) is located in an area (15) recessed in the enveloping and/or surrounding material (8) of the milling head (3).

8. An indexable cutting insert (1) according to claims 1 through 7, characterized in that the enveloping and/or surrounding material (8) of the milling head (3) works in conjunction with the disk surface (13).

9. An indexable cutting insert (3.1) according to claim 1, characterized in that the mounting pin (8.1) is equipped on the other end (13.1) thereof with a tapped area (14.1) serving to fix the said mounting pin (8.1) in the material of the milling head (2.1).

10. An indexable cutting insert (3.1) according to claim 9, characterized in that the mounting pin (8.1) is equipped with a frontal cylindrical area (15.1) for the rotational mounting of the indexable cutting insert (3.1), as well as in the central area (16.1), with a conically designed area for the fixation in the carrier material of the milling head (2.1), onto which conically designed area abuts the tapped area (14.1) following for the purpose of bracing in the carrier material.

11. An indexable cutting insert (3.1) according to claim 10, characterized in that the mounting pin (8.1) works in conjunction with a conicity provided in the bore in the central, conically designed area (16.1).

12. An indexable cutting insert (3.1) according to claim 11, characterized in that a hex socket (18.1) is disposed coaxially to the shank axis (17.1) of the mounting pin (8.1).

13. An indexable cutting insert (3.1) according to claim 1, characterized in that for the purpose of using centrifugal force to secure the indexable cutting insert (2.1), the freely rotatably mounted indexable cutting insert (3.1) is equipped with a circumferential groove (19.1) wherein engages the track ring (20.1) or cog (21.1) disposed on the milling head (2.1)

14. An indexable cutting insert (3.1) according to claim 13, characterized in that the circumferential groove (19.1) is radially disposed on the indexable cutting insert (3.1).

15. An indexable cutting insert (3.1) according to claim 13, characterized in that the circumferential groove (19.1) is disposed on the frontal or the rear support surface (22.1) of the indexable cutting insert (3.1).
